(19) United States
(12) Patent Application Publication
(10) Pub. No.: US 2009/0184871 A1
(43) Pub. Date: Jul. 23, 2009

(54) GPS with time integrated call initiation

(76) Inventor: Mostafa Tofighbakhsh, Cupertino, CA (US)

Correspondence Address: AT& T LEGAL DEPARTMENT - Monka;ATTN: PATENT DOCKETING, ROOM 2A - 207, ONE AT & T WAY, BEDMINSTER, NJ, 07921, US

(21) Appl. No.: 12/009,882

(22) Filed: Jan. 23, 2008

(51) Int. Cl. G01S 5/00; G06F 19/00

(52) U.S. Cl. 342/357.08; 701/300

(57) ABSTRACT

A method and system are disclosed for determining relative movement among a plurality of entities using temporal data and position data. The methodology involves receiving position and temporal data corresponding to positions of the entities, synchronizing the temporal data and outputting the synchronized data to enable a determination of relative movement that takes into account network latency.

### FIELD OF THE INVENTION

The present invention relates generally to determining relative movement among entities using position and time data, and more particularly, to a system and method utilizing GPS/time data over a network that takes into account network latency by synchronizing the time of the position data for the entities with high precision.

### BACKGROUND OF THE INVENTION

There are several known protocols for synchronizing multiple clocks over communications networks, such as for example, IEEE 1588 and Network Time Protocol (NTP). IEEE 1588 provides a standard method to synchronize devices on a network with sub-microsecond precision. In accordance with IEEE 1588 and as shown in FIG. 1, a plurality of network access devices (NADs) 102₁, 102₂, 102₃, . . . 102_{N} are configured to communicate with each other via a generic access/backbone 104, the details of which are not relevant here. A plurality of slave clocks (SCs) 106 disposed throughout the communications network 104 are slaved to a master clock (MC) 108 to ensure that events and timestamps for all NADs 102 on the network 104 use the same time base. IEEE 1588 is optimized for user-administered, distributed systems, minimal use of network bandwidth, and low processing overhead. IEEE 1588 provides sub-microsecond synchronization over long distances with standard cabling. As is known in the art, IEEE 1588 (1) determines which device serves as the MC, and (2) measures and corrects time skew caused by clock offsets and network delays. When a system is initialized, the IEEE 1588 protocol uses the Best Master Clock (BMC) algorithm to automatically determine which clock in the network is the most precise. It becomes the master clock. All other clocks become slaves and synchronize their clocks with the master.

The time difference (skew) between the master clock and slave clock is a combination of the clock offset and message transmission delay. Correcting the clock skew is done in two phases—offset correction and delay correction. The MC 108 initiates offset correction using “sync” and “follow-up” messages as shown in FIG. 2, of an illustrative protocol—IEEE 1588. When the MC 108 sends a sync message across the network 104, each SC 106 uses its local clock to timestamp the arrival of the sync message and compares it to the actual sync transmission timestamp in the master clock's follow-up message. For the example shown in FIG. 2, the MC sends out a sync message at master time 100 seconds, which corresponds to slave time 82 at the SC. The offset is calculated to be 18 seconds (100-82). The difference between the two timestamps represents the offset of the SC plus the message transmission delay. The SC then adjusts its local clock by this difference at point A of FIG. 2. To correct for the message transmission delay, the SC uses a second set of sync and follow-up messages with its corrected clock to calculate the master-to-slave delay at point B of FIG. 2. The second set of messages is necessary to account for variations in network delays. The SC timestamps the sending of a delay request message. The MC timestamps the arrival of the delay request message and then sends a delay response message with the delay request arrival timestamp at point C of FIG. 2. The difference between the timestamps is the slave-to-master delay. The slave averages the two directional delays and then adjusts the clock by the delay to synchronize the two clocks. In this example, the delay request of two seconds and the delay response of two seconds sum to a four second slave to master delay. As master and slave clocks drift independently, periodically repeating offset correction and delay correction keeps the clocks synchronized. There are alternative protocols such as Network Time Protocol (NTP) or Simple Network Time Protocol (SNTP) that can also provide this function and the depicted expedient is merely intended to be illustrative.

### SUMMARY OF THE INVENTION

In accordance with a first aspect of the invention, there is disclosed a methodology of determining relative movement among a plurality of entities using temporal data and position data. The method generally comprises the steps of: receiving first position data and first temporal data corresponding to the first position data for a first entity among the plurality of entities; receiving second position data and second temporal data corresponding to the second position data for a second entity among the plurality of entities; synchronizing the first and second temporal data; and outputting the synchronized first and second temporal data with the first and second position data.

In accordance with another aspect of the invention, there is disclosed a computing device configured to determine relative movement among a plurality of entities using temporal data and position data. The device generally has the ability to: receive from a communication network, first position data and first temporal data corresponding to the first position data for a first entity among the plurality of entities; receive from the communications network, second position data and second temporal data corresponding to the second position data for a second entity among the plurality of entities; synchronize the first and second temporal data; and output the synchronized first and second temporal data with the first and second position data.

These and further aspects and advantages of the invention will become apparent to those skilled in the art as the present invention is described with particular reference to the accompanying drawings.

### BRIEF DESCRIPTION OF THE DRAWINGS

FIG. 1 is a diagram of a prior art communications network that utilizes synchronized clock timing;

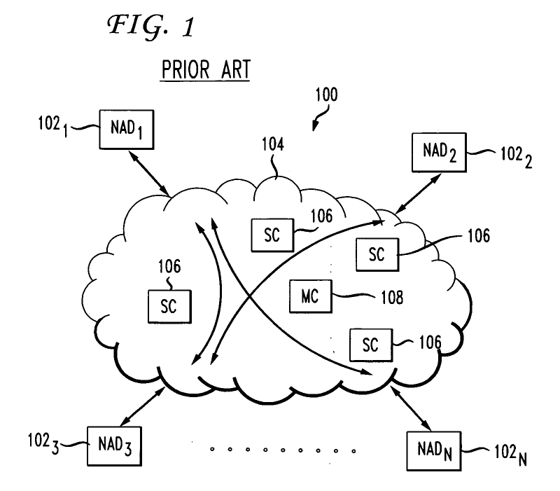

FIG. 2 is a schematic diagram of an illustrative protocol—IEEE 1588;

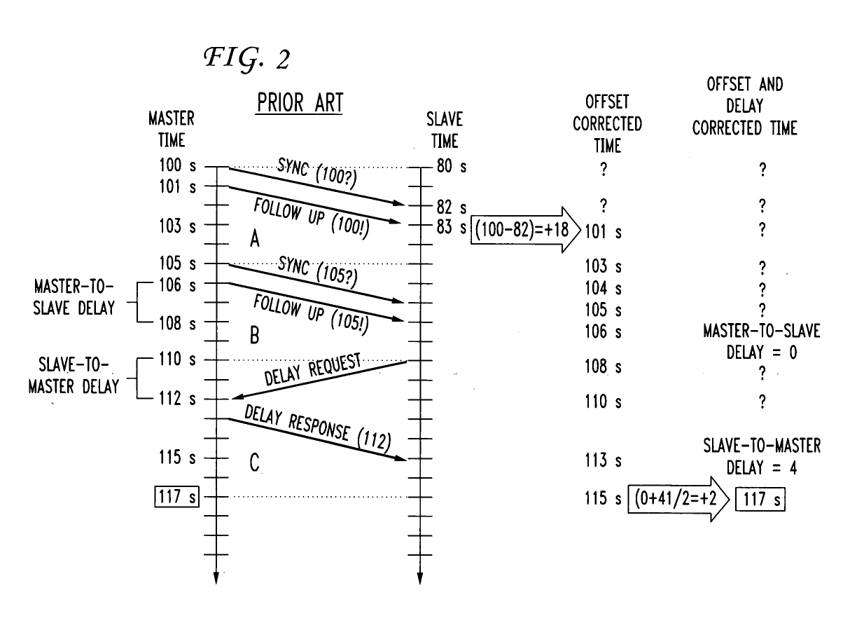

FIG. 3 is a schematic of an exemplary network and application in accordance with an aspect of the present invention; and

FIG. 4 is a flowchart of a method in accordance with the current invention.

### DESCRIPTION OF THE INVENTION

Embodiments of the invention will be described with reference to the accompanying drawing figures wherein like numbers represent like elements throughout. Before embodiments of the invention are explained in detail, it is to be understood that the invention is not limited in its application to the details of the examples set forth in the following description or illustrated in the figures. The invention is capable of other embodiments and of being practiced or carried out in a variety of applications and in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The present invention utilizes network timing synchronization protocols, such as described above, to enable a determination of relative movement among a plurality of entities using temporal data and position data.

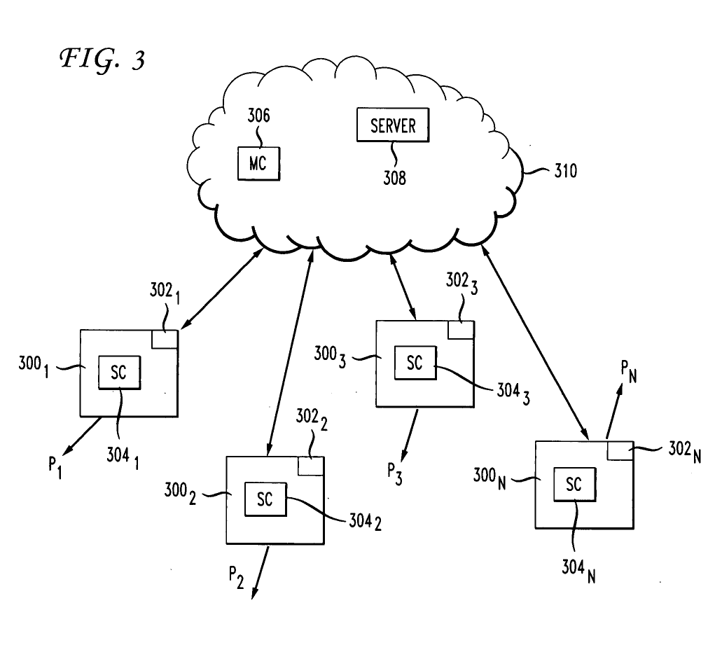

FIG. 3 is a schematic of an exemplary network and application wherein a plurality of entities in the form of objects 300₁, 300₂, 300₃, . . . 300_{N}, each having a corresponding transponder 302₁, 302₂, 302₃, . . . 302_{N} of the type well known in the art. In addition, each object contains a slave clock (SC) 304₁, 304₂, 304₃, . . . 304_{N} for the purpose of coordinating action with the master clock (MC) 306. Once time skew between all of the SCs 304's and the MC 306 have been corrected for, extremely accurate (i.e. sub-microsecond) time information regarding each object can be gathered. This example shows how the plurality of objects can be tracked as they move relative to each other over respective paths P₁, P₂, P₃, . . . P_{N}, using methods according to the invention. Each transponder 302 is capable of being interrogated and the specific information encoded therein, captured by a server 308 disposed somewhere in a network 310. Each transponder 302 may also contain GPS information relating to the specific position of the object. As described above, the relative GPS/time data for the objects is processed by software/firmware/hardware associated with server 308 to determine the relative movement between the objects using GPS/time data. This information may then be used for a variety of purposes. One possible application could be when two entities (two cell phones/PDAs or a cell phone/PDA and a fixed NAD within a retail establishment) are within a particular range, say 400 yards, messages are sent to either or both entity alerting each of this. The above described mobile-to-mobile application could help individuals locate each other, while the mobile-to-retail application could alert consumers of a sale or special deals available immediately. Additional examples of information encoded within transponders 302 and capable of being interrogated could be a mobile NAD (i.e. cell phone, PDA or the like), vehicle ID (i.e. boat, car, truck, aircraft or the like) or shipping information (i.e. bill of lading, container/package ID, product type, product quantity or the like) just to name a few examples. It will be appreciated by those skilled in the art, that this example may be extended to any “entity” including but not limited to, people, animals, vehicles, packages, and the like.

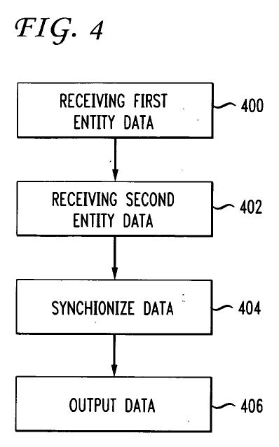

Referring to FIG. 4, there is shown a flow diagram illustrating a method in accordance with an aspect of this invention for determining relative movement among a plurality of entities using temporal data and position data for a network access device or “entity” that can have position data associated therewith. The inventive method generally comprises (at a central computing device, server, or combination of networked devices) the first step 400 of receiving first position data and first temporal data corresponding to the first position data for a first entity among the plurality of entities. The position data may be obtained through global positioning (GPS) information, such as from a handheld unit associated with a person, a network access device, or the like. Similarly, the temporal data may be obtained from the same source as GPS receivers and/or network access devices have internal clocks. In step 402, second position data and second temporal data corresponding to the second position data for a second entity among the plurality of entities are received. The first and second temporal data are then synchronized at step 404 using, for example, the techniques described above with respect to IEEE 1588, NTP or the like. This synchronized data is output at step 406 to an application, such as a program, system or the like for determining the relative movement between the entities.

The foregoing detailed description is to be understood as being in every respect illustrative and exemplary, but not restrictive, and the scope of the invention disclosed herein is not to be determined from the description of the invention, but rather from the claims as interpreted according to the full breadth permitted by the patent laws. It is to be understood that various modifications will be implemented by those skilled in the art, without departing from the scope and spirit of the invention.

I claim:

1. A method for determining relative movement among a plurality of entities using temporal data and position data, comprising the steps of:
receiving first position data and first temporal data corresponding to the first position data for a first entity among the plurality of entities;
receiving second position data and second temporal data corresponding to the second position data for a second entity among the plurality of entities;
synchronizing the first and second temporal data; and
outputting the synchronized first and second temporal data with the first and second position data.

2. The method recited in claim 1, further comprising the step of determining the relative movement between the first and second entities using the synchronized temporal data and the position data.

3. The method recited in claim 1, wherein the synchronization is according to IEEE 1588.

4. The method recited in claim 1, wherein the synchronization is according to NTP.

5. The method recited in claim 1, further comprising the step of receiving the synchronized temporal and position data over a communications network.

6. The method recited in claim 5, wherein the communications network is an internet protocol (IP) network.

7. The method recited in claim 5, wherein the synchronization comprises the steps of comparing a master clock and at least one slave clock on the communication network.

8. The method recited in claim 1, wherein the position data is derived from the global position system (GPS).

9. The method recited in claim 1, further comprising the step of receiving encoded data from a transponder associated with at least one of the entities.

10. A computing device configured to determine relative movement among a plurality of entities using temporal data and position data, by:
receiving from a communication network, first position data and first temporal data corresponding to the first position data for a first entity among the plurality of entities;
receiving from the communications network, second position data and second temporal data corresponding to the second position data for a second entity among the plurality of entities;
synchronizing the first and second temporal data; and
outputting the synchronized first and second temporal data with the first and second position data.

11. The computing device recited in claim 10, further configured to determine the relative movement between the first and second entities using the synchronized temporal data and the position data.

12. The computing device recited in claim 10, wherein the synchronization is according to IEEE 1588.

13. The computing device recited in claim 10, wherein the synchronization is according to Network Time Protocol (NTP).

14. The computing device recited in claim 10, wherein the synchronization comprises comparing a master clock and at least one slave clock on the communication network.

15. The method recited in claim 10, wherein the position data is derived from the global position system (GPS).

16. The computing device recited in claim 10, further configured to receive encoded data from a transponder associated with at least one of the entities.
